(19) United States
(12) Patent Application Publication
(10) Pub. No.: US 2009/0285620 A1
(43) Pub. Date: Nov. 19, 2009

(54) SOFT PEN SHAFT

(76) Inventor: TAI CHIUNG TUNG, Taipei (TW)

Correspondence Address: TAI-CHIUNG TUNG, P.O. BOX 11192, TAIPEI, 10099, omitted

(21) Appl. No.: 12/122,691

(22) Filed: May 17, 2008

(51) Int. Cl. B43K 23/00

(52) U.S. Cl. 401/195

(57) ABSTRACT

A shaft cover has a surrounding decorative element without a joint line. The pen shaft (3) has positioning elements (30) on the surface; a soft plate (10) has a decorative image (12) and covers the outline of the pen shaft (3), and the positioning holes (11) of the soft plate (10) receive the positioning element (30) for substantially positioning the shaft cover (1); and a positioning element (20) at the bottom face is used for covering on to the joint line (13) formed on the shaft cover (1) and jointing with the pen shaft (3) after corresponding with the positioning element (30).

### BACKGROUND OF THE INVENTION

1. Field of the Invention

The present invention relates to a soft pen shaft with esthetic design on the shaft cover.

2. Description of Related Art

Pens are everyday essential writing tool. For increasing the attractive characteristics of the pen, manufacturers usually print letters or patterns on the surface of the pen shaft. However, letters and patterns on the pen shaft are too flat to look interesting.

For having a 3-dimensional pattern with more verities and the better esthetic appearance on the surface of the pen shaft, manufactures make mold to form the soft casing sleeve for positioning around the pen shaft, and the protruded pattern can substantially provide a better esthetic appearance. U.S. Pat. No. 6,479,005 discloses a method of forming a soft shaft cover having multi-colored and raised decorations for positioning around the pen shaft. The method includes steps of preparing a mold consisting of two halves, on inner surfaces of which mold cavities are symmetrically formed; providing recesses in the mold cavities on one of the two halves of mold so that these recesses are mirror images of selected words, letters or designs; laying the half of mold having the recesses in a horizontal position so that the recesses are at a horizontally lowest position relative the mold cavity in which the recesses are provided; injecting differently colored soft plastic materials into the recesses and waiting until the plastic materials in the recesses are set; closing the two halves of the mold and positioning the closed mold in an upright position; inserting a core rod in each mold cavity; injecting another amount of soft plastic material into the mold cavities and waiting until the plastic material is set; and removing the core rods and separating the two halves of mold to remove the molded soft shaft cover from the mold cavities.

However, prior art has the following defects, for example:

1. soft shaft cover formed by the above molding process comprises a joint line where the two halves joins when the two halves are separated to release the soft shaft cover from the mold cavity, thus forming a defect on the smooth surface of the soft shaft cover;

2. general soft shaft cover only have one raised image produced on the surface, a plurality or near 360° area coverage is not possible, thus the above defects have set the limitation to providing esthetic effect on the soft shaft cover; and

3. material to make the soft shaft cover is limited, and material such as fabric, leather or other materials are not suitable for the conventional art, thus the variety thereof is limited.

### SUMMARY OF THE INVENTION

According to an embodiment of the present invention, the pen shaft comprises a shaft cover having a soft texture and a surrounding decorative image.

According to another embodiment of the present invention, the material for making the shaft cover can be selected from various materials without limitation.

According to another embodiment of the present invention, the joint line on the shaft cover can be disguised into a simple design.

The present invention provides two embodiments that may overcome the defects of the conventional art described above. According to the first embodiment, the pen shaft having a soft texture and a decorative shaft cover, comprises:

a pen shaft (3) comprising a positioning element (30);

a soft plate (10), having a decorative image (12) covering around the pen shaft (3); wherein the soft plate (10) comprises positioning holes (11) on the two sides for fitting the positioning element (30) in order to further secure the shaft cover (1); and

a positioning plate (2), comprising a positioning element (20) formed at the bottom surface thereof for covering the joint line (13) of the shaft cover (1) and jointing with the pen shaft (3) after corresponding with the positioning element (30).

The above joint line (13) comprises a geometric shape.

The positioning element (30) comprises a plurality of positioning pillars (301) positioned along a line and protruding out of the pen shaft (3). The positioning holes (11) are employed for receiving the positioning pillars (301) on block wings (15a, 15b) of the two side of the soft plate (10). The block wings (15a, 15b) are alternately positioned to coordinate with each other, and the joint line (13) is formed to form a gear structure.

The plurality of positioning pillars (301) of the positioning element (30) may be arranged in dual lines protruding out of the pen shaft (3). The positioning holes (11) are employed for receiving the positioning pillars (301) on long wings (16a, 16b) of the two side of the soft plate (10). The long wings long (16a, 16b) are alternately positioned to coordinate with each other, and the joint line (13) is formed as a straight line.

The above positioning plate (2) comprises a rear protrusion (21) extending from the rear end and a front protrusion (22) extending from the frontal end thereof. The pen shaft (3) comprises a rear flange (31) having a rear positioning groove (311) at the rear end and a frontal flange (32) having a frontal positioning groove (321) at the frontal end thereof. The above rear protrusion (21) is fitted into the rear positioning groove (311) and the frontal protrusion (22) is fitted into the frontal positioning groove (321) in order to secure the jointing of the positioning plate (2) with the pen shaft (3).

The pen shaft having a surrounding decoration comprises the soft plate (10) and the decorative image (12). The decorative image (12) comprises a variety of colors.

The material for making the soft plate (10) of the pen shaft (3) with the surrounding decoration can be selected from a group consisting of rubber, silicon, soft plastic, leather, fabric and metallic material.

According to another embodiment of the present invention, the pen shaft having a soft texture and a decorative shaft cover, comprises:

a pen shaft (3);

a soft shaft cover (1), covering the pen shaft (3), for wrapping around the pen shaft (3) with a soft plate (10) having a joint line (13); and

a positioning plate (2), covering the joint line (13) of the shaft cover (1) and jointing with the pen shaft (3).

The above positioning plate (2) comprises a rear protrusion (21) extending from a rear end thereof and a front protrusion (22) extending from a frontal end thereof. The pen shaft (3) comprises a rear flange (31) having a rear positioning groove (311) at a rear end thereof and a frontal flange (32) having a frontal positioning groove (321) at a frontal end thereof. The rear protrusion (21) is fitted into the rear positioning groove (311) and the frontal protrusion (22) is fitted into the frontal positioning groove (321) in order to secure the joint of the positioning plate (2) with the pen shaft (3). The joint of the positioning plate (2), the shaft cover (1) and the pen shaft (3) can be reinforced by using an adhesive glue.

Compared to the conventional art, the present invention has at least the following advantages.

1. The decorative image (12) can be displayed in nearly 360° and thereby provide a better visual esthetic effect.

2. The joint line 13 of the shaft cover (1) is covered by the positioning plate (2) to overcome the defects of the conventional art that exposes the joint line.

3. The material for making the soft plate (10) can be selected from a group consisting of rubber, silicon, soft plastic, leather, fabric and metallic material. Thus, a variety of materials may be used without limitation to increase the esthetic appearance of the pen shaft (3).

### BRIEF DESCRIPTION OF THE DRAWING

For a more complete understanding of the present invention, reference will now be made to the following detailed description of preferred embodiments taken in conjunction with the following accompanying drawings.

FIG. 1 is a perspective view of a pen shaft according to a first embodiment of the present invention.

FIG. 2 is an exploded view of a pen shaft according to the first embodiment of the present invention.

FIG. 3 is a sectional side view taken along X-X of a pen shaft according to the first embodiment of the present invention.

FIG. 4 is a perspective view of a shaft cover according to the first embodiment of the present invention.

FIG. 5 is a perspective view of a pen shaft jointing with a shaft cover according to the first embodiment of the present invention.

FIG. 6 is a sectional side view taken along Y-Y of a pen shaft according to the first embodiment of the present invention.

FIGS. 7A and 7B are perspective views of a shaft cover according to another embodiment of the present invention.

FIG. 8 is a perspective view of a pen shaft without the clip and the distal end according to the first embodiment of the present invention.

FIG. 9 is a perspective view of a pen shaft according to a second embodiment of the present invention.

FIG. 10 is a sectional side view taken along Z-Z of a pen shaft according to the second embodiment of the present invention.

FIG. 11 is a perspective view of a shaft cover according to the second embodiment of the present invention.

FIG. 12 is a perspective view showing the pen shaft jointing with a shaft cover according to the second embodiment of the present invention.

FIG. 13 is another perspective view of a pen shaft according to the second embodiment of the present invention.

FIG. 14 is a sectional side view taken along W-W of a pen shaft according to the second embodiment of the present invention.

FIG. 15 is a perspective view of a pen shaft according to a third embodiment of the present invention.

FIG. 16 is a sectional side view taken along A-A of a pen shaft according to the third embodiment of the present invention.

### DETAIL DESCRIPTION OF THE INVENTION

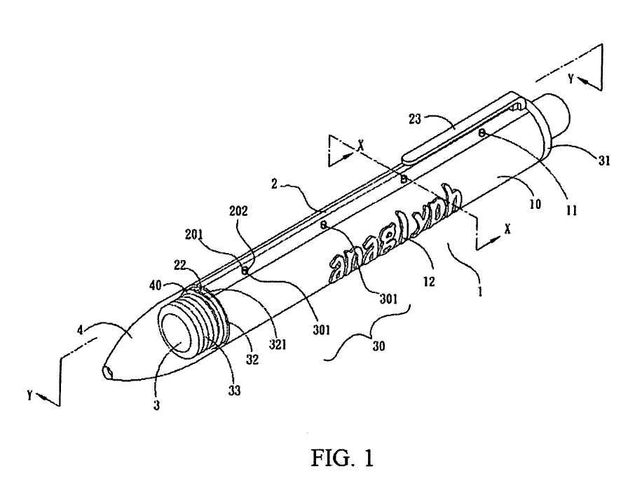

FIG. 1-3 respectively show a perspective view, an exploded view, a sectional side view taken along X-X of a pen shaft, and a perspective view of a pen shaft without a clip and a distal end according to the first embodiment of the present invention. The pen shaft with soft texture and a surround decoration comprises:

a pen shaft (3), comprising a positioning element (30);

a soft plate (10), having a decorative image (12) curved covering around the pen shaft 3; comprising positioning holes (11) formed on the two sides thereof for fitting the positioning element (30) to further secure the shaft cover (1); and

a positioning plate (2), having a positioning element (20) at a bottom surface thereof for covering the joint line (13) of the shaft cover (1) and jointing with the pen shaft (3) after corresponding with the positioning element (30).

The joint line (13) has a geometric shape or other shapes, for example, triangular, wave format, or others according to the requirement of the users or the manufacturers.

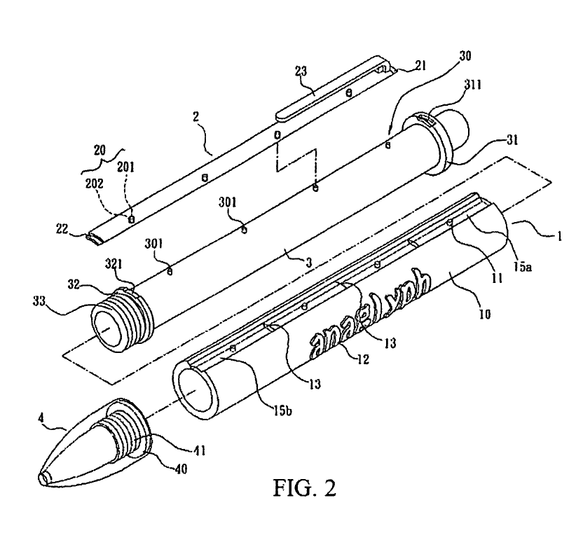

The positioning element (30) comprises a plurality of positioning pillars (301) arranged along a line and protrude out of the pen shaft (3). The above positioning holes (11) are used for receiving the positioning pillars (301) on block wings (15a) and (15b) formed on two side of the soft plate (10) as shown in FIG. 4. The block wings (15a) and (15b) are alternately positioned to coordinate with each other as shown in FIG. 2. The joint line (13) may comprise a gear structure.

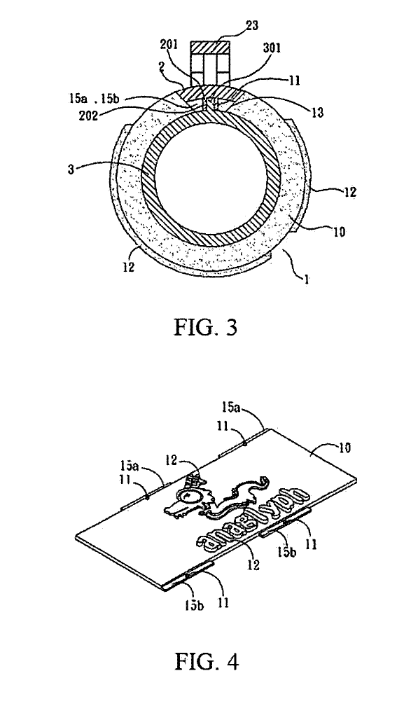

According to the above description, the soft plate (10) as shown in FIG. 4 displays a large decorative image (12), and the block wings (15a) and (15b) are alternately positioned to coordinate with each other. Furthermore, the thickness of the block wings (15a) and (15b) is smaller than the soft plate (10), and therefore, the block wings (15a) and (15b) form a straight slit on the surface of the shaft cover (1) after rolling up process, as shown FIG. 3. The slit can provide provision to inlay the positioning plate (2), and the positioning plate (2) covers the joint line (13) and the conjunction of the block wings (15a) and (15b), and accordingly covers the joint line (13).

The material for making the positioning plate (2) can be selected from a group consisting of metal or plastic, and the color can be as the same or different from that of the shaft cover (1). Furthermore, the positioning element (20) comprises a plurality of protrusions (201) positioned on a surface of the positioning plate (2). A positioning hole (202) corresponding to the positioning pillars (301) is formed at a central region of every protrusion (201) for positioning the positioning element (20) and the positioning element (30).

Furthermore, the positioning element (20) comprises a plurality of protrusions (201) on a surface of the positioning plate (2). A positioning hole (202) corresponding to the positioning pillars (301) is formed at a central region of every protrusion (201).

Accordingly, the shaft cover (1) can be properly positioned on the pen shaft (3).

Furthermore, the positioning plate (2) may comprise a pen clip (23) for facilitating carriage by the user.

The material for making the soft plate (10) may be selected from a group consisting of rubber, silicon, soft plastic, fabric, leather, metallic material or others, according to the design of the pen shaft 3.

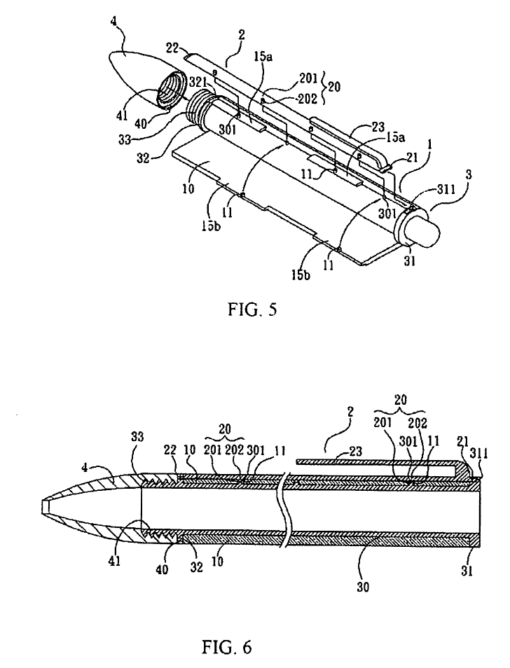

Referring to FIGS. 5 and 6, a perspective view of a pen shaft jointing with a shaft cover and a sectional side view taken along Y-Y of a pen shaft according to the first embodiment of the present invention are shown. The positioning pillars (301) positioned on the surface of a side of the pen shaft (3) can be inlayed into the positioning holes (11) on the block wing (15a) to position on a side of the soft plate (10). Next, the positioning pillars (301) positioned on the surface of another side of the pen shaft (3) can be inlayed into the positioning holes (11) on the wing (15b) to position on another side of the soft plate (10). Thus, the block wings (15a) and (15b) are alternately positioned. Furthermore, the positioning plate (2) covers the block wings (15a) and (15b) to substantially secure and inlay the positioning pillars (301) into positioning element (20) positioned on the bottom thereof.

For more securely positioning the positioning plate (2), the positioning plate (2) comprises a rear protrusion (21) at the rear end thereof and a frontal positioning protrusion (22) on a frontal end thereof. Thus, the rear protrusion (21) can be fitted into the rear positioning groove (311) formed on the rear flange (31) of the pen shaft (3) and the frontal protrusion (22) can be fitted into the frontal positioning groove (321) formed on the frontal flange (32) of the pen shaft (3) to secure the joint of the positioning plate (2) with the pen shaft (3). Furthermore, the frontal protrusion (22) can be horizontally fitted into the frontal positioning groove (321) formed on the frontal flange (32) of the pen shaft (3), and the female threading portion (41) of the pen head (4) can be fitted with the male threading portion (33) of the pen shaft (3) to clamp the frontal protrusion (22) by the positioning groove (40) of the pen head (4) in order to substantially joint the positioning plate (2) with the pen shaft (3).

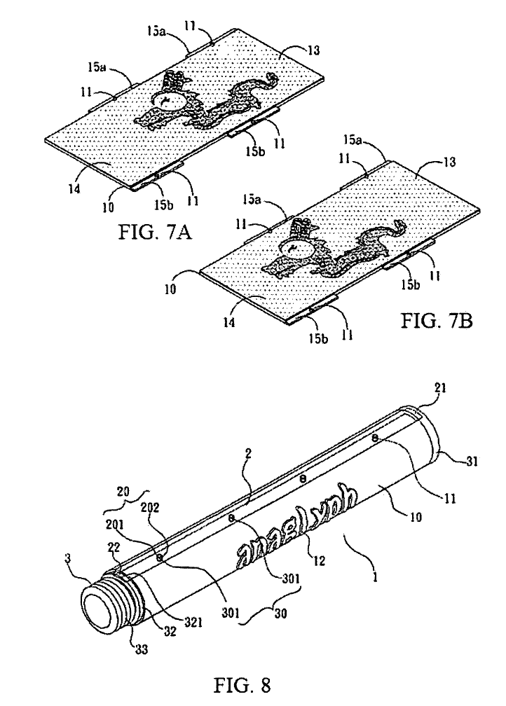

Referring to FIGS. 7A and 7B, perspective views of a shaft cover according to another embodiment of the present invention are shown. As shown, a lenticular image (14) having patterns, letters or signs is attached on the soft plate (10). The soft plate (10) comprises a flat surface to easily attach the lenticular image (14) thereon. The lenticular image (14) comprises 3D image displaying function. It is comprised of two major parts, a base image and an upper lenticular lens comprises a long string plano-convex lens, and the lens enables the user to see the base image in different positions when viewed from the different angle. Therefore, by printing two alternate different images and attaching the lenticular lens, an effect of changeable image can be provided for the user to view of various patterns from the different angles, as shown in FIG. 7A or FIG. 7B. The above patterns can be in more variety of forms, and the number of the lenticular images can be accordingly increased to increase to add value to the pen.

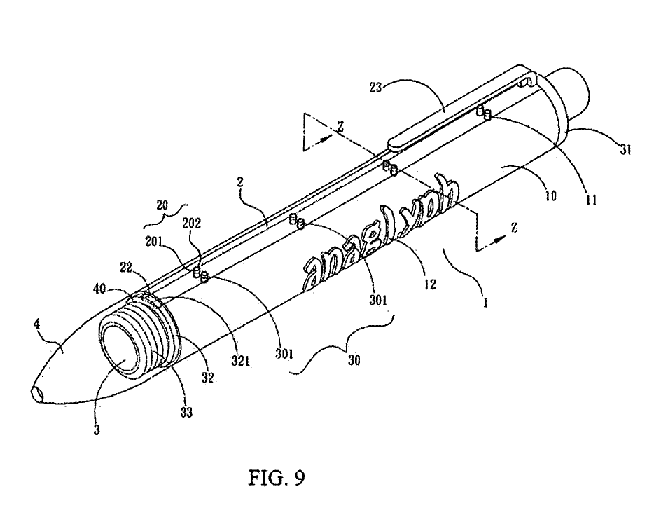

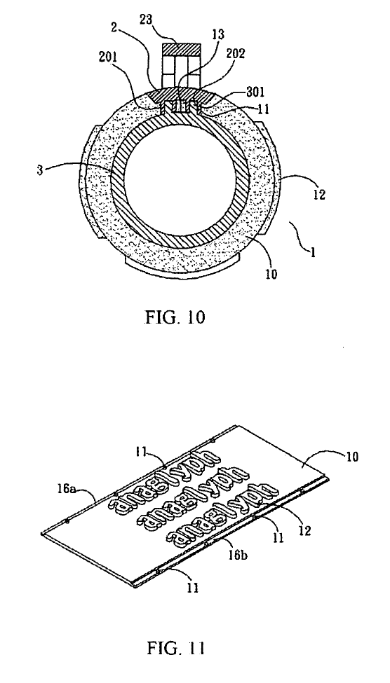

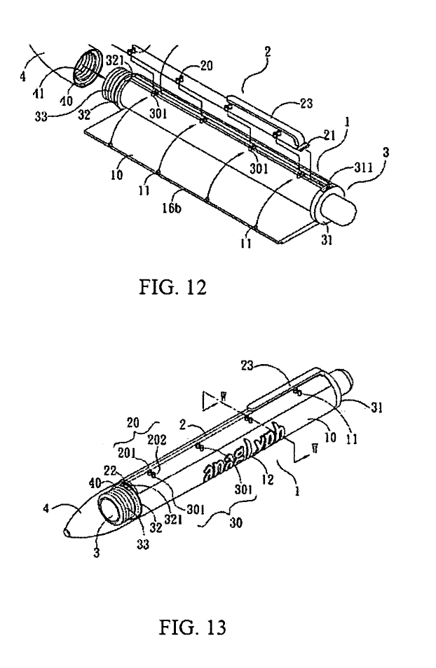

In the second embodiment, referring to FIG. 9-12, a perspective view, a sectional side view taken along Z-Z of a pen shaft, a perspective view of a shaft cover and a perspective view of a pen shaft jointing with a shaft cover are shown. The second embodiment is similar to the first embodiment except for the positioning pillars (301) of the positioning element (30) are arranged in dual lines. Accordingly, the positioning holes (11) of the long wings (16a) and (16b) of the soft plate (10) are formed corresponding to the positioning pillars (301). The thickness of the long wings (16a) and (16b) is smaller than the soft plate (10), therefore, the long wings (16a) and (16b) forms a straight slit on the surface of the shaft cover (1) after the positioning pillars (301) are inlayed into the positioning holes (11) of the long wings (16a) and (16b). The slit can provide the provision to inlay the positioning plate (2), and the positioning plate (2) covers joint line (13) and the conjunction of the long wings (16a) and (16b).

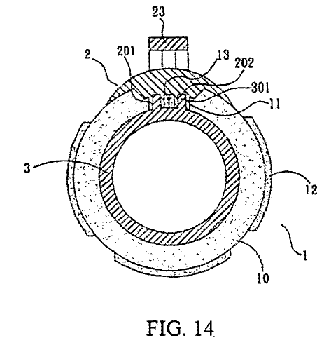

Referring to FIGS. 13 and 14, perspective view and a sectional side view taken along W-W of a pen shaft according to the second embodiment of the present invention are shown. In the present embodiment, the positioning plate (2) protrudes out of the surface of the pen shaft (3). In other words, the outline of the positioning plate (2) can be in an arch shape as the pen shaft (3) after jointing together, and the positioning plate (2) can be higher than the outline of the pen shaft (3). This feature can be altered according to the actual requirement.

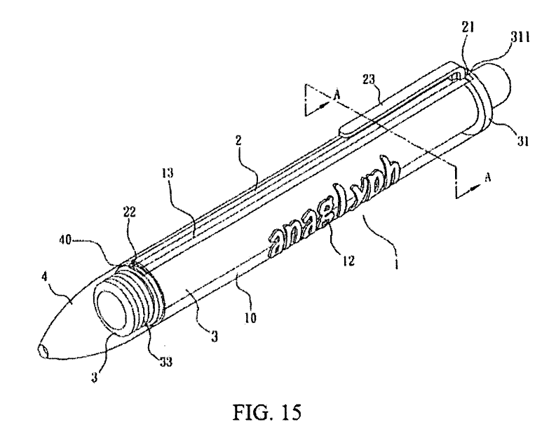

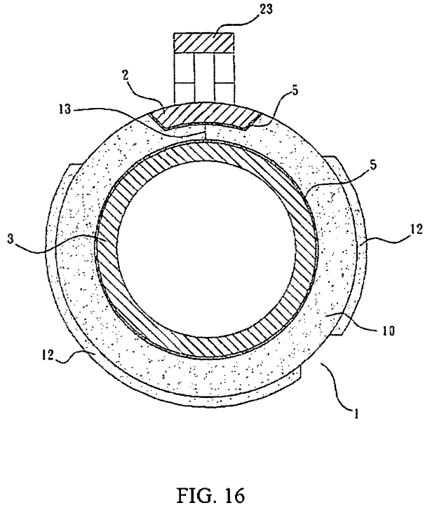

In the third embodiment, referring to FIG. 15-16, a perspective view and a sectional side view taken along A-A of a pen shaft according to the third embodiment of the present invention are shown. The pen shaft has a soft texture and a surrounding decorative shaft cover, which comprises:

a pen shaft (3),

a soft shaft cover (1), covering the pen shaft (3), wrapping around the pen shaft (3) with a soft plate (10) having a joint line (13); and

a positioning plate (2), covering the joint line (13) of the shaft cover (1) and jointing with the pen shaft (3).

After jointing with the shaft cover (1), the positioning plate (2) and the pen shaft (3), the positioning plate (2) can be assembled to cover the joint line (13) of the shaft cover (1).

Furthermore, the shaft cover (1) can comprise a layer of adhesive glue (5) to fit and increase throughput, and reduce the production cost.

The above positioning plate (2) comprises a rear protrusion (21) extending at the rear end thereof, and a front protrusion (22) extending at the frontal end thereof. The pen shaft (3) comprises a rear flange (31) having a rear positioning groove (311) at the rear end and a frontal flange (32) having a frontal positioning groove (321) at the frontal end. The rear protrusion (21) is fitted into the rear positioning groove (311) and the frontal protrusion (22) is fitted into the frontal positioning groove (321). The pen head (4) fitted to the pen shaft (3) to substantially joint the positioning plate (2) with the shaft cover (1).

In addition, the joint of the positioning plate (2), the shaft cover (1) and the pen shaft (3) can be reinforced by using the adhesive glue (5) to provide a better secured positioning effect and reduce the production cost.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A pen shaft having a soft texture and a surround decoration, comprising:
a pen shaft, comprising a positioning element;
a soft plate, having a decorative image covering around the pen shaft, comprising positioning holes formed on two sides for fitting the positioning element to further secure the shaft cover; and
a positioning plate, comprising a positioning element at a bottom surface thereof for covering on a joint line formed on the shaft cover and jointing with the pen shaft after corresponding with the positioning element.

2. The pen shaft having a soft texture and a surround decoration according to claim 1, wherein said joint line comprises a geometric shape.

3. The pen shaft having a soft texture and a surround decoration according to claim 1, wherein said positioning element comprises a plurality of positioning pillars arranged along a line and protrude out of the pen shaft, and the positioning holes are used for receiving the positioning pillars on block wings formed on the two sides of the soft plate, wherein the block wings are alternately positioned to coordinate with each other, and wherein the joint line comprises a gear structure.

4. The pen shaft having a soft texture and a surround decoration according to claim 1, wherein said positioning element comprises positioning pillars arranged in dual lines and protruding on a surface of the pen shaft, and the positioning holes of the long wings of the soft plate are formed corresponding to the positioning pillars; and the joint line is formed by joint the long wings and becomes a straight line after rolling up the soft plate.

5. The pen shaft having a soft texture and a surround decoration according to claim 1, wherein said positioning plate comprises a rear protrusion extending at a rear end thereof and a front protrusion extending at a frontal end thereof; the pen shaft comprises a rear flange having a rear positioning groove at a rear end thereof and a frontal flange having a frontal positioning groove at a frontal end thereof; and the rear protrusion is fitted into the rear positioning groove and the frontal protrusion is fitted into the frontal positioning groove to secure joint of the positioning plate with the pen shaft.

6. The pen shaft having a soft texture and a surround decoration according to claim 1, wherein said shaft cover comprises the soft plate and a decorative image made of a latex or soft plastic material, and the decorative image comprises various colors.

7. The pen shaft having a soft texture and a surround decoration according to claim 1, wherein a material for making said soft plate is selected from the group consisting of rubber, silicon, soft plastic, leather, fabric or metallic material.

8. A pen shaft having a soft texture and a surround decoration, comprising:
a pen shaft;
a soft shaft cover, covering the pen shaft, wrapping around the pen shaft with a soft plate having a joint line; and
a positioning plate, covering the joint line of the shaft cover and jointing with the pen shaft.

9. The pen shaft having a soft texture and a surround decoration according to claim 8, wherein said positioning plate comprises a rear protrusion extending at a rear end thereof and a front protrusion extending at a frontal end thereof, wherein the pen shaft comprises a rear flange having a rear positioning groove at a rear end thereof and a frontal flange having a frontal positioning groove at a frontal end thereof, and wherein the rear protrusion is fitted into the rear positioning groove and the frontal protrusion is fitted into the frontal positioning groove to secure a joint of the positioning plate with the pen shaft; and the joint of the positioning plate, the shaft cover and the pen shaft is reinforced using an adhesive glue.
